(19) United States
(12) Patent Application Publication
(10) Pub. No.: US 2011/0236907 A1
(43) Pub. Date: Sep. 29, 2011

(54) RADIOLABLED CYCLOPAMINE ASSAY FOR THE SMOOTHENED RECEPTOR

(76) Inventors: Wei Chen, Chapel Hill, NC (US); Lawrence S. Barak, Durham, NC (US); Jiangbo Wang, Durham, NC (US); Robert J. Lefkowitz, Durham, NC (US); Herbert Kim Lyerly, Chapel Hill, NC (US)

(21) Appl. No.: 12/999,922

(22) PCT Filed: Jun. 16, 2009
(86) PCT No.: PCT/US09/47497

§ 371 Date: Apr. 29, 2011

Related U.S. Application Data
(62) Division of application No. 61/073,250, filed on Jun. 17, 2008.

(51) Int. Cl. G01N 23/00

(52) U.S. Cl. 435/7.2

(57) ABSTRACT

The present invention discloses novel methods for screening compositions for both agonist and antagonist activity on the smoothened receptor. The assay tests ligands on the activity of the receptor using a cyclopamine binding and ultra high receptor expression.

This application claims priority over U.S. provisional application No. 61/073,250 filed on Jun. 17, 2008 and is incorporated herein in its entirety by reference.

### FEDERALLY SPONSORED RESEARCH

This invention was made with Government support under: supported in part by NIH grant R01CA113656 (Innovative Assays for Oncogenic Hedgehog Signaling). The Government has certain rights to this invention.

### REFERENCE TO RELATED APPLICATIONS

Incorporated by reference in its entirety is the provisional application of Chen et al. entitled “Smoothened Receptor Modulators”, filed Jun. 17, 2008, application No. 61/129,302.

Incorporated by reference in its entirety is the PCT application of Chen et al. entitled “Smoothened Receptor Modulators”, filed Jun. 16, 2009, attorney docket number 01579-1450.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method of screening selected compositions for agonist and antagonist activity on a receptor. In particular, the invention relates to screening the Smoothened receptor for the effects of test ligand compositions on the activity of the receptor. Also, in particular, it relates to a cyclopamine binding assay using ultra high receptor expression.

2. Description of Related Art

The Hedgehog (Hh) proteins are known as a family of signal molecules that can act as mediators in the developmental processes such as growth and patterning, for both invertebrates and vertebrates. It is known that changes in the Hh pathway can lead to birth defects and in adult cells can lead to cancer. While the extent to which Hh participates and controls the growth of cancer cells is not completely known, it is already known that cancer related to brain, skin, muscle, stomach, pancreas, lung, prostate and bladder all involve the Hh pathway. Nature Vol 432, Nov. 18, 2004 pgs 324-331. Two transmembrane protein receptors, Patched (Ptc) and Smoothened (Smo) mediate the responses to the Hh proteins. Ptc, a 12 transmembrane protein regulates (inhibits) the activity of the Smo protein, a 7 transmembrane protein similar in structure to a Frizzled protein of the Wnt family rather than the well known 7 transmembrane G Protein Coupled Receptors (GPCRs). The Smo proteins appear to be involved in embryonic pattern formation and in stem cell renewal, tissue repair and regeneration unlike the GPCR family of proteins. When not inhibited by Ptc, Smo signals are transduced to Gli. When Hh binds to Ptc, it relieves the inhibitory control of Smo. For example, excess signaling of Smo when Ptc is blocked from inhibiting Smo activity is known to contribute to medulloblastoma while inhibition of Smo leads to an elimination of tumors. Cancer Res 2005; 65; (12) Jun. 15, 2005 pgs 4975-4978.

The Hh pathway in vertebrates is considerably more complex than in the well studied D. melanogaster. There are three Hh genes in mammals, sonic, Indian and desert hedgehog (Shh, Ihh and Dhh), two Ptc genes (Ptc1 and Ptc2) and three Gli homologues (Gli1, Gli2 and Gli3). Nature Reviews, volume 6, April 2005 pages 307-317.

In the situation where there is excess Hh (for example, excess Shh), the Ptc carries inhibiting mutations or the Smo inappropriately signals, there appears to be conditions that lead to several forms of cancer, especially in vertebrates. It appears that Ptc normally acts to keep cell proliferation in check by keeping Smo in check by modulating its signaling, specifically through Smo inhibition. It also appears that loss of Hh signaling, which could result in essentially permanent inhibition of Smo, also creates metabolic problems and appears to result in cyclopia and other developmental defects of the face, forebrain and other organs and structures.

Compositions and assays are known, which act as agonists or antagonists in the Hh pathway, including with the Smo receptor. In U.S. Pat. No. 6,492,139 to de Sauvage, there is disclosed novel homologues of Smo as well as the sequence of both human and rat Smo. There are also described several antibodies to vertebrate Smo. In U.S. Pat. No. 7,115,653 to Baxter there is disclosed compounds which correct or inhibit an aberrant or unwanted growth state by antagonizing a normal Ptc pathway or agonizing a Smo or Hh activity.

A large number of regulators of the Hh pathway including the Smo function are disclosed in U.S. Pat. No. 7,098,196 and US Patent Application No. US 2006/0128639 both to Beachy. These compounds are shown to modulate the Hh pathway and several utilities of such compounds are described in detail. The Beachy references are hereby incorporated by reference including the disclosure of the utility of compositions which involve control of Smo and the entire Hh pathway activity. The assays described in these disclosures for discovery of modulators involve reporter gene based assays which measure the end stage of the cascade of events, i.e. transcriptional modulation. A reporter gene construct is inserted into a reagent cell in order to generate a detection signal dependant on Ptc loss of function, Hh gain of function, Smo gain of function or stimulation by Hh itself. These signaling events though are difficult to follow in a timely manner using a reporter assay which may take many up to 2 days or more after the events have occurred to provide an appropriate readout. Additionally, because the readout is many biochemical steps past the point where a change occurs in Smo activity, reporter assays may falsely report changes in Smo activities that are upstream of the reporter assay but due to Smo downstream biochemical and biological events rather than Smo activities or Smo upstream activities. The related art of the Smo receptor discloses no other useful cell based assays for following the Hh pathway.

Methods for screening GPCRs in a direct manner, in a cell based assay, have been known for almost 10 years. In U.S. Pat. No. 5,891,646 to Barak there is disclosed a method for screening GPCRs using a conjugate of a beta-arrestin and a detectable (reporter) molecule. The receptor is shown to translocate between the cytosol and the cell membrane upon activation of the receptor by an agonist. It can also translocate between the cell membrane and the membrane of structures within the cytosol. There is no prior evidence that this assay has utility for any other receptor group as evidenced by its long standing acceptance and lack of reported utility for any other receptor group.

Activity-dependant internalization of Smoothened was disclosed as mediated by β-arrestin 2 and GRK2 in Science Vol 306 Dec. 24, 2004 pages 2257-2260 by inventors of the present technology. The authors of that paper postulated that this knowledge “may provide a platform” for a discovery assay and have used this information to develop an assay based on reporter molecules during the desensitization process. The need for secondary screens or alternative primary screens for the Shh still exists, however. See also PCT application US06/62102 filed Dec. 14, 2006 by some of the inventors of the present technology

Radioligand binding assay methods are well known as are the pitfalls and parameters for successful assays. Am. J. Physiol. 265, L421-L429, 1993. In determining the specific ligand to use as a radioligand for competitive analysis of antagonists and agonists several criteria usually need to be met to consider the assay practical as well as accurate. One important criterion is that a radioligand needs to have a high receptor affinity and the higher the better. However, a high affinity “must go hand in hand with high specific activity”. Am J. Physiol. Supra L422. A radioligand with the lowest nonspecific (i.e. non-receptor) binding will be the best assay radioligand. Normally, a specific binding of at least 50% is considered barely adequate with 70% being good and 90% being an excellent radioligand. It is known that, within reason, the higher the receptor concentration the better the binding and a higher receptor concentration might in some cases compensate for some radioligands that are barely adequate in their specific binding characteristics. It is also possible in such situations that no amount of receptors can compensate for barely adequate specific binding and ligands under 50% specific binding are considered inadequate for assay use.

The steroidal alkaloid cyclopamine is known to be an antagonist ligand of the smoothened receptor. It has been shown that such binding by cyclopamine and its various known derivatives, inhibits the Hh pathway activation by binding directly to Smo. The binding interaction is localized to the pethahelical bundle and is thought to influence the Smo receptor protein conformation. While the affinity of cyclopamine for the Smo receptor is relatively good, the specific activity is low as is the amount of specific binding cyclopamine has when compared with its non-specific binding. Based on the standard methods for doing radiolabeled assays cyclopamine would not be considered a candidate.

There are currently no ligands that are known that would be suitable ligands for use in a radiolabeled assay of the Smo receptor. Accordingly, it would be useful to find ligands and a method to assay antagonists and agonists of the Smo receptor using a radiolabeled assay. Therefore, there is a need for an assay, preferably radiolabeled, to find antagonists and agonists of the Smo receptor that meets the criteria for radiolabeled assays without the associated problems of poor ligands.

### SUMMARY OF THE INVENTION

It has been surprisingly discovered that cyclopamine and its derivatives can be used as a radioligand for the Smo receptor when used on a cell or portion thereof wherein the cell has been transfected to hyper-overexpress the Smo receptor. Accordingly, the assay can be used to detect agonists and antagonists by competitive binding as a primary or secondary screen. In addition, the assay is quick accurate and real time in discovering that the Smoothened receptor is bound by a ligand.

Accordingly, in one embodiment of the invention there is a method for determining if a test compound is a ligand of the Smoothened receptor comprising combining the test compound with a radiolabeled cyclopamine or a derivative thereof and exposing them to one or more cells expressing or over expressing the Smoothened receptor at a rate of at least 200,000 receptors per cell and determining the competition binding of the test compound.

In another embodiment of the invention, there is disclosed a method for assessing the binding of a test composition to the Smoothened receptor comprising:
a) selecting a radiolabeled cyclopamine ligand or a cyclopamine derivative ligand thereof;
b) preparing a plurality of cells that over express the Smoothened receptor at a rate of at least 200,000 receptors per cell;
c) determining the binding of the selected radiolabeled ligand to the cells without the presence of a test compound;
d) exposing a selected concentration of radiolabeled ligand and test compound to a selected amount of the cells over expressing the Smoothened receptor; and
e) comparing the amount of radiolabeled ligand binding to the cells without the presence of the test compound with the amount of radiolabeled ligand binding to cells in the presence of the test compound to determine the binding ability of the test compound.

These and other objects of the present invention will be clear when taken in view of the detailed specification and disclosure in conjunction with the appended figures.

### BRIEF DESCRIPTION OF THE DRAWINGS

FIG. 1 is a graph showing the binding of tritiated cyclopamine to cells hyper over expressing the Smoothened receptor.

FIG. 2 is a graph showing the specific and nonspecific binding of tritiated cyclopamine at various concentrations to cells hyper over expressing the Smoothened receptor.

FIGS. 3 and 4 are the amino acid and nucleotide sequence for the Smoothened receptor.

### DETAILED DESCRIPTION OF THE INVENTION

The general description of the invention and how to use the assay is stated in the Brief Summary above. This detailed description defines the meaning of the terms used herein and specifically describes embodiments in order for those skilled in the art to practice the invention. The above interests in successfully assaying compositions for binding to the Smoothened receptor as either an agonist or antagonist for use in treating a disease condition including cancer can readily be seen from the disclosure which follows and are met by the present invention. This detailed description defines the meaning of the terms used herein and specifically describes embodiments in order for those skilled in the art to practice the invention.

The present invention discloses a method for determining if a test compound is a ligand, either agonist or antagonist, of the Smoothened receptor. It has been surprisingly discovered that when radiolabeled cyclopamine or a ligand derivative of cyclopamine is used with cells that hyper over-express the Smoothened receptor that cyclopamine or its derivatives can be successfully used in a radiolabeled competitive type assay. Absent the results of the tests herein, the prior art does not teach that cyclopamine could be useful at all even with hyper over expressed smoothened receptor in a given cell.

The term “cell,” as used herein, refers to cells useful in the methods of the present invention including eukaryotic and prokaryotic cells, including but not limited to bacterial cells, yeast cells, fungal cells, insect cells, nematode cells, and plant or animal cells. Suitable animal cells include, but are not limited to HEK cells, HeLa cells, COS cells, and various primary mammalian cells. Cells contained in intact animals, including but not limited to nematodes, zebrafish (and other transparent or semi-transparent animals) and fruitflies, may also be used in the methods of the present invention. An animal model expressing a hyper or over expressing cell of the Smoothened receptor throughout its tissues, or within a particular organ or tissue type, will be useful in studying cellular targets of known or unknown ligands in the Smoothened receptor. Likewise, fractions of cells having the over expressed Smoothened receptor could also be used, cancerous tissue or the like.

As used herein, “exposing a cell to a test compound or a cyclopamine radioligand” means bringing the cell exterior in contact with the test compound and cyclopamine radioligand. Where the test compound and radio ligand are being used in the present assay screening for Smoothened ligand activity, exposure is carried out under conditions that would permit binding of a ligand to a Smoothened receptor expressed in that cell.

When a test compound has “binding ability on the Smoothened receptor” it is meant that it has displaced at least a portion of the binding radio ligand in the competitive assay of the present invention. The binding would indicate either the ligand has a measurable agonistic activity or an antagonistic activity. No displacement or very little displacement would indicate that it is not a ligand or that it is binding by non specific means or it binds to an independent site noncompetitively. It also refers to measurable activity that would qualify it as a partial agonist or partial antagonist. Determination as an agonist or antagonist can be accomplished by previously known methods for determining active compounds. Accordingly, the methods for determining activity of a test compound are similar to competitive radiolabeled assays know in the past however with a ligand with poor affinity and with a Smoothened receptor hyper expressing cell.

The first procedure is to prepare cells which hyper over express the Smoothened receptor at a rate of at least 200,000 per cell. In one embodiment the cells express at least 500,000 receptors per cell and in yet another embodiment the cells express at least 1 million Smoothened receptors per cell. Once prepared the whole cell or membrane fractions can be used in an assay of the present invention.

The sequence of the Smoothened receptor is well known. This is true for most mammals including the human Smoothened receptor. One embodiment the present invention relates to an assay using the human Smoothened receptor. The production of the receptor from many sources including cloned genes by genetic methods is well known. The host cells for over expression can be transformed with vectors containing DNA encoding synthetic or natural Smo receptors. The Vectors are used herein to amplify the DNA encoding the receptor.

Vectors useful for practicing the present invention include plasmids, viruses (including phage), retroviruses and integratable DNA fragments. The vector replicates and functions independently of the host genome and in some instances may integrate into the host genome itself. Suitable vectors will contain replicon and control sequences which are derived from species compatible with the intended expression host. Transformed cells express the Smo receptor and enough vectors transfecting the particular cell can give the desired hyper over-expression needed by the present invention, that is, at least 200,000 receptors per cell.

In preparing the radioligand of the present invention cyclopamine or a derivative (meaning one having Smo ligand binding capability similar to cyclopamine) is prepared or purchased commercially usually in the form of H isotopes or I isotopes of the desired cyclopamine. Other isotopes are known and in one embodiment the H isotope is used. The preparation of the radioligand is well within the scope of the present invention. In determining the binding affinity of the radioligand used in the present invention the assay is done to equilibrium normal at a temperature of 0-40 degrees C.

The assay of the present invention is a competitive radioligand binding assay using the particular transformed cells claimed herein. The following examples are embodiments which teach the utility and general methods used to achieve the results desired. The teaching of the embodiments, however, are not intended to be limiting and other methods known in the art can be used based on the teaching of the embodiments.

### EXAMPLES

### Example 1

### Preparation of Transfected Cell Lines

A cell line is produced using known transfection methods, permanently expressing the Human Smo receptor at a rate of at least 500,000 receptors per cell, over expressed GRK2, and beta-arrestin2 green fluorescent protein was derived from U2OS cells transfected with human Smo contained in the plasmid expression vector PRK7-Smo. Cells were grown under G418 and zeocin selection. Single colonies were picked using confocal microscopy by evaluating them for their ability to translocate beta-arrestin green fluorescent protein to membrane bound Smo in the absence of exogenously applied ligand.

### Example 2

### Tritiated Cyclopamine Binding

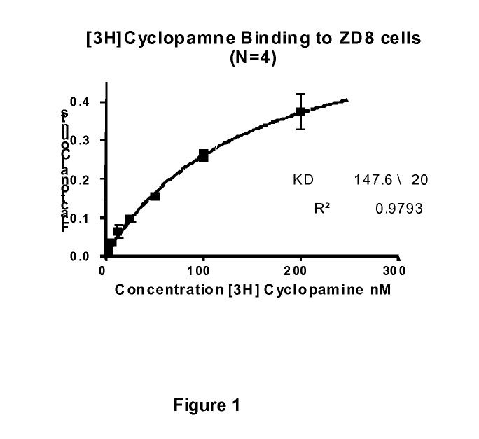

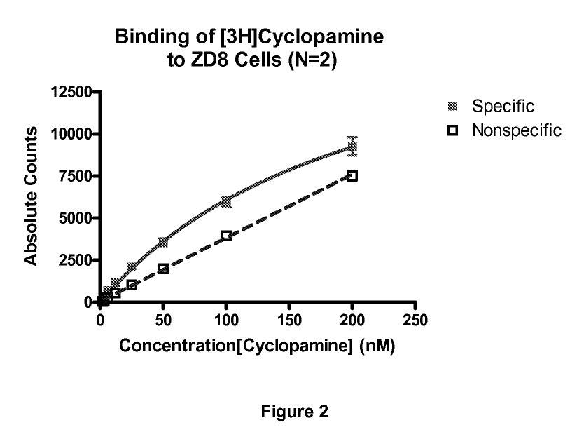

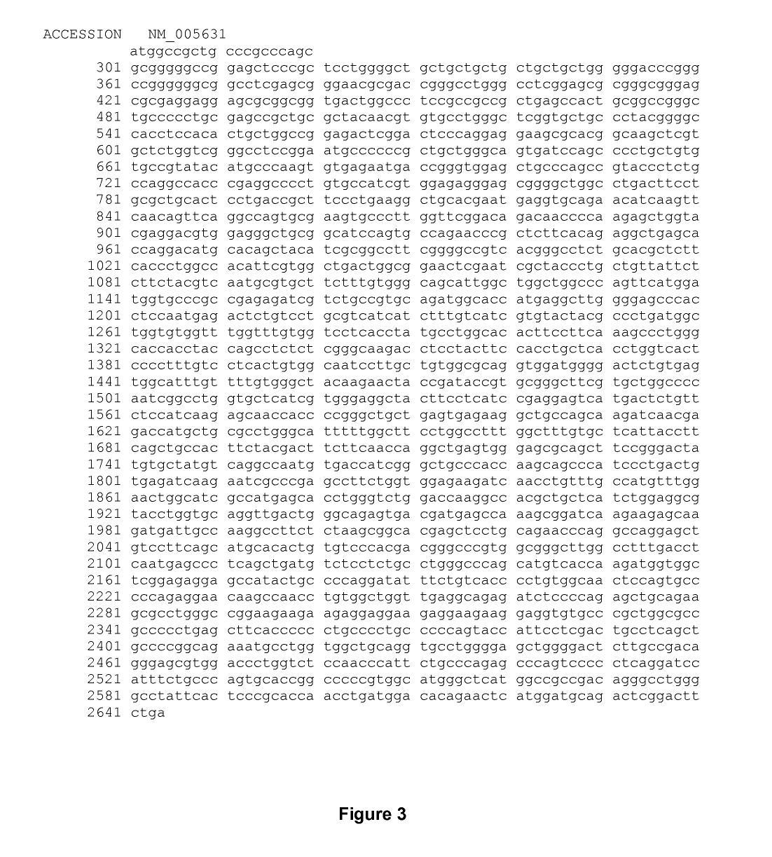

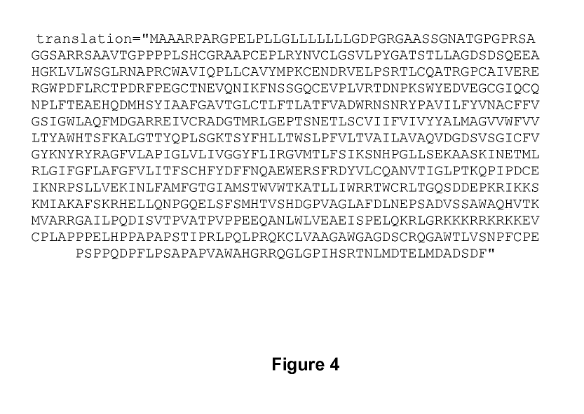

Cells permanently expressing approximately 10 picomoles per milligram of human Smoothened receptor were plated at 125,000 cells per well in a 12 well tissue culture plate in medium essential media with 10 percent fetal bovine serum in a 5 percent CO2 incubator. The following day the media was replaced with 100 microliters cold phosphate buffered saline at pH 7.2 following three washes in PBS. Tritiated cyclopamine was added in 50 microliters of cold PBS to each well at varying concentrations and the plate was incubated over ice for ninety minutes on a cell rocker. For controls, duplicate wells containing tritiated cyclopamine and an excess of cold cyclopamine, at 20 micromolar were also prepared and incubated under the same conditions. Following the incubation the cells were washed three times in cold PBS and 100 microliters of 0.1 molar NaOH was added to each well for 30 to 60 minutes to extract the remaining bound tritiated cyclopamine. The extracted material was added to a vial containing 2 ml of scintillation fluid. Duplicate or triplicate wells were assayed for each curve. The results are displayed in FIGS. 1 and 2.

### Example 3

### Tritiated Cyclopamine Assay for Competition Binding of the Smo Receptor

The assay was used to evaluate the affinity to Smo of the compounds SANT1 and SANT2 (antagonists), cold cyclopamine, the cyclopamine derivatives KAAD-cyclopamine and jervine, and the Smo antagonists SAG1 and SAG2. The assay can be performed as follows: cells plated as above are exposed simultaneously to a fixed concentration of Tritiated cyclopamine, say 10 nanomolar, and a concentration of test compound. Test compound is applied to different wells such that a wide range of concentrations are evaluated. Incubations are carried out over 60-90 minutes over ice or as above. The cells are washed and extracted as above, and the amount of remaining Tritiated cyclopamine determined as described above. By determining the amount of remaining Tritiated cyclopamine remaining specifically bound to the Smo receptor at the various test ligand concentrations the affinity of the test ligands for the Smo receptor can be determined.

### Example 4

### Membranes

Membranes prepared using standard methods containing smoothened receptors will be frozen at −20 degrees C. and thawed prior to binding experiments or freshly prepared. They will be utilized in assessing the binding of either direct competitors of cyclopamine for the receptor or allosteric modulators that bind at alternative sites not occupied by cyclopamine or its derivatives. Additionally, these membranes could be utilized to assess other biochemical properties of the smoothened receptor such as phosphorylation, binding of G protein subunits, or the receptors association with other cell proteins that comprise components of the signaling pathway such as arrestin and patched.

What is claimed is:

1. A method for determining if a test compound is a ligand of the Smoothened receptor comprising combining the test compound with a radiolabeled cyclopamine or a derivative thereof and exposing them to one or more cells expressing over expressing the Smoothened receptor at a rate of at least 200,000 receptors per cell and determining the competition binding of the test compound.

2. A method for assessing the binding of a test composition to the Smoothened receptor comprising:
a) selecting a radiolabeled cyclopamine ligand or a cyclopamine derivative ligand thereof;
b) preparing a plurality of cells that over express the Smoothened receptor at a rate of at least 200,000 receptors per cell;
c) determining the binding of the selected radiolabeled ligand to the cells without the presence of a test compound;
d) exposing a selected concentration of radiolabeled ligand and test compound to a selected amount of the cells over expressing the Smoothened receptor; and
e) comparing the amount of radiolabeled ligand binding to the cells without the presence of the test compound with the amount of radiolabeled ligand binding to cells in the presence of the test compound to determine the binding ability of the test compound.
